(19) United States
(12) Patent Application Publication
(10) Pub. No.: US 2007/0189696 A1
(43) Pub. Date: Aug. 16, 2007

(54) Optical board connector assembly

(76) Inventors: Jan Peter Karel Van Koetsem, Bazel (BE); Hendrikus Petrus Gijsbertus Van Der Steen, Den Dungen Noord Brabant (NL)

Correspondence Address: HARRINGTON & SMITH, PC, 4 RESEARCH DRIVE, SHELTON, CT, 06484-6212, US

(21) Appl. No.: 10/568,400

(22) PCT Filed: Aug. 6, 2004
(86) PCT No.: PCT/EP04/51737

§ 371 Date: Oct. 31, 2006

(30) Foreign Application Priority Data
Aug. 14, 2003 (NL) 1024108

(51) Int. Cl. G02B 6/36

(52) U.S. Cl. 385/137; 385/89

(57) ABSTRACT

The invention relates to an optical board connector assembly for optically connecting an array of optical fibres to a circuit board embedded device including a connector housing including a support structure and at least one fibre fixation part. The fibre fixation part includes a ferrule part for containing said optical fibres and a support part adapted to cooperate with said support structure such that said ferrule part protrudes at least partly from said connector housing. The invention also relates to a fibre fixation part for use in such an assembly.

The invention relates to an optical board connector assembly for optically connecting an array of optical fibres to a circuit board embedded device comprising:
a connector housing comprising a support structure;
at least one fibre fixation part.

WO 02/061481 discloses an optical connector for use with an electro-optical board. The optical connector comprises a female self-alignment body having a tapered channel and a tapered male self-alignment body sized to fit closely into the tapered channel of the female body. Off-board optical fibres terminate in the male body such that optical signals provided over the fibres may be transmitted via a plurality of optical conductors in a right angle interface body with an integrated mirror to and from a plurality of embedded optical fibres in a multi-layer circuit board.

A disadvantage of the prior art optical connector is that the distance of the optical fibres to the embedded device cannot be accurately controlled, resulting in optical losses. The distance in the prior art optical connector is determined by a plurality of factors, including the fit between the female and male bodies and the female body and the right angle interface body. Generally optical components, such as lenses, are employed to bridge the distance between the optical fibres and the embedded device.

It is an object of the present invention to provide an optical board connector assembly that enables a better control of the gap between the optical fibres and the embedded device.

This object is achieved by providing an optical board connector assembly characterized in that said fibre fixation part comprises a ferrule part for holding said optical fibres and a support part adapted to cooperate with said support structure such that said ferrule part protrudes at least partly from said connector housing. The connector housing of such an assembly enables the ferrule part to protrude from the housing such that the accurately fixated fibres in this ferrule part may closely approach the embedded optical device. The control of the gap between the ferrule part and the embedded device in enhanced as only this distance is to be controlled.

In an embodiment of the invention the assembly comprises at least one resilient member adapted to exert a force on said fibre fixation part in the direction of said protrusion of said ferrule part. Such a resilient member allows the gradual built-up of force during placement of the board connector on the device such that a low loss connection results. Preferably, the resilient member is pre-biased such that the ferrule part is pushed outward from the connector housing in order to protrude from this housing on mating.

In an embodiment of the invention the connector housing comprises a space adapted to accommodate said optical fibres in a variety of bending states. Such a housing is able to accommodate the optical fibres if the protruding ferrule part moves partly inwards on connection and allows fixation, e.g. by epoxy, of the optical cables near the entrance of the connector housing.

In an embodiment of the invention the ferrule part comprises a two-dimensional high-density array of holes for containing said optical fibres. Such an assembly enables a board connector for high density optical communication, e.g. over 32×32, 64×64 or even higher dimensioned cables. Accurate control of the gap between the ferrule part and the embedded device is even more critical for such two-dimensional configurations.

In an embodiment of the invention the ferrule part comprises a plurality of high-density through-holes comprising substantially straight edges. Preferably the holes have a substantially polygonal shape, such as an octagon. Such ferrule parts provides a relatively lower cost board connector with a ferrule part of suitable accuracy to allow low loss communication, in particular for multi-mode communication.

In an embodiment of the invention the connector housing is adapted to allow float of said fibre fixation part in one or more dimensions. Float of the ferrule part is e.g. advantageous in the x-y plane, as such a float allows alignment of the ferrule part with the embedded device on connection.

The invention also relates to a fibre fixation part for use in an optical board connector assembly as described above.

The invention will be further illustrated with reference to the attached drawings, which show a preferred embodiment according to the invention. It will be understood that the invention is not in any way restricted to this specific and preferred embodiment.

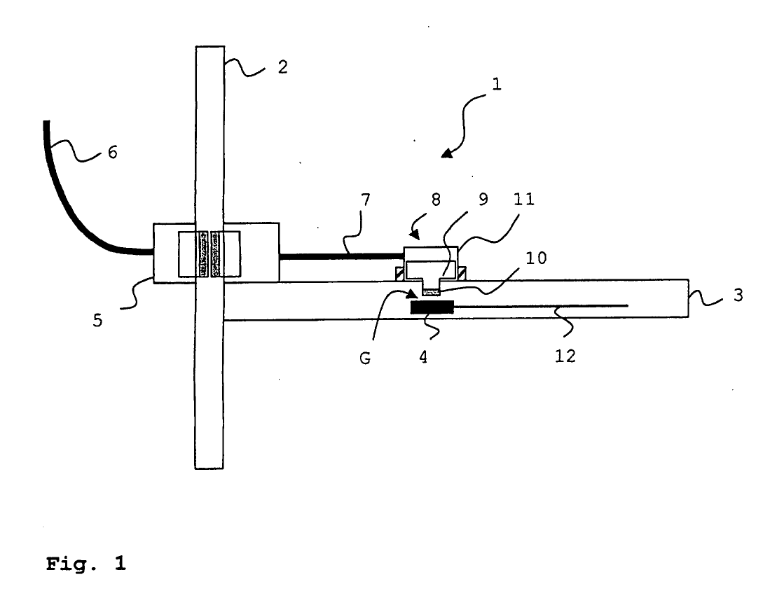

FIG. 1 shows a schematical illustration of an optical backpanel system;

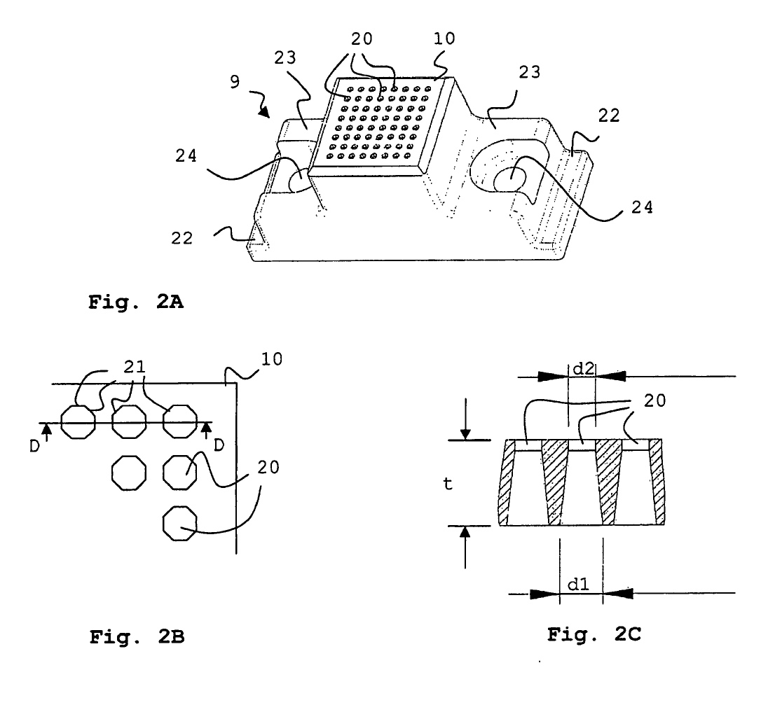

FIGS. 2A-2C show a fibre fixation part according to an embodiment of the invention;

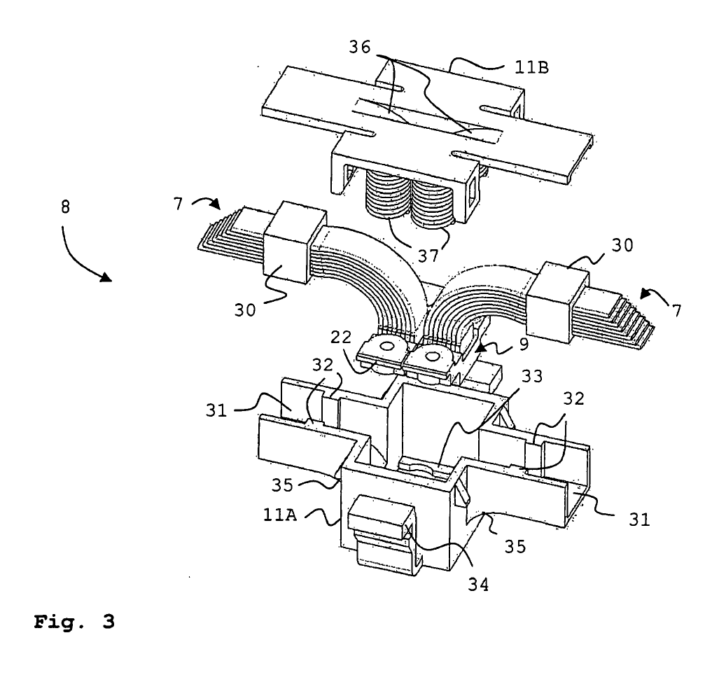

FIG. 3 shows an exploded view of an optical board connector assembly according to an embodiment of the invention;

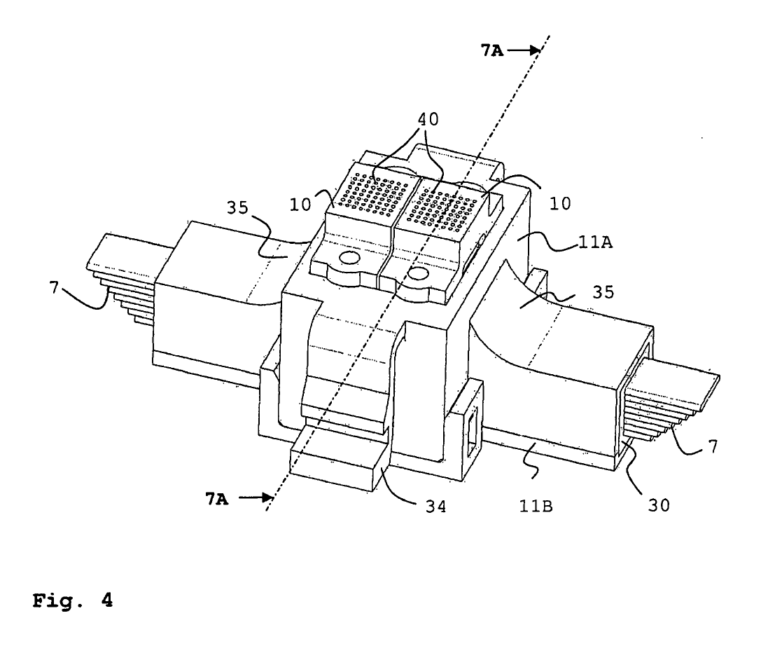

FIG. 4 shows a view of an optical board connector assembly in assembled state according to an embodiment of the invention;

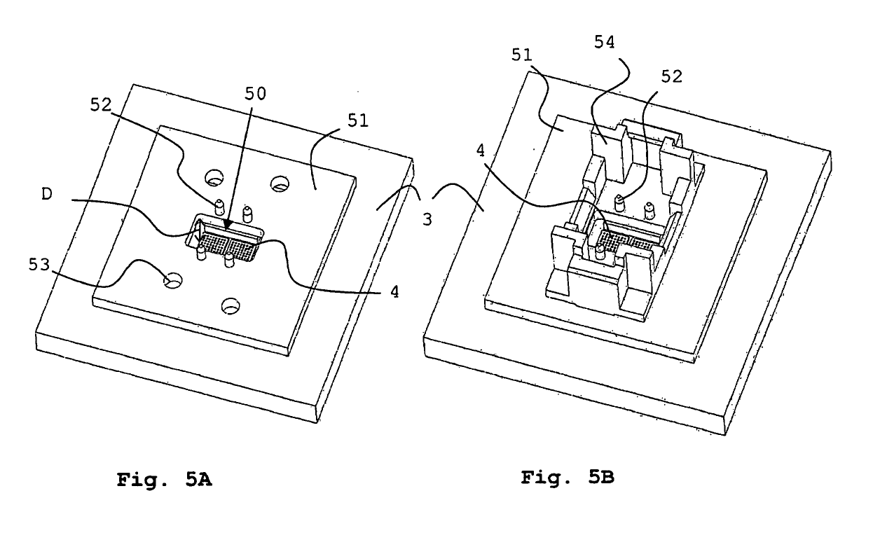

FIGS. 5A and 5B show a system card comprising an embedded device;

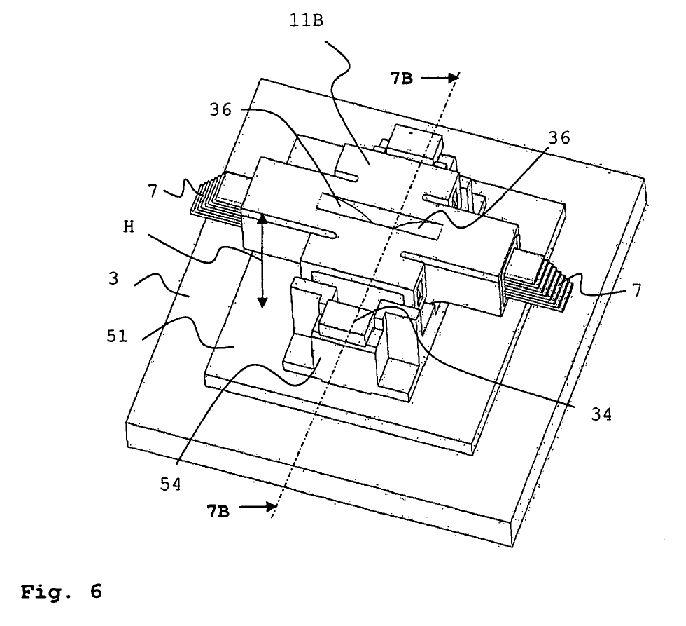

FIG. 6 shows an optical board connector assembly according to the invention optically connected to a board embedded device;

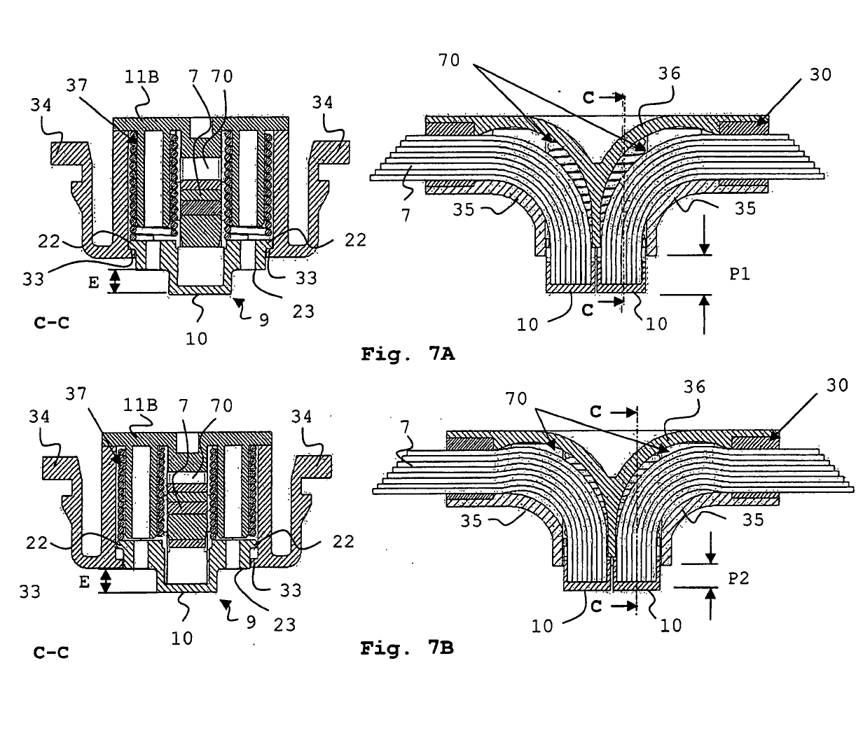

FIGS. 7A and 7B show cross sections along 7A-7A of FIG. 4 and along 7B-7B of FIG. 6 of the optical board connector assembly respectively.

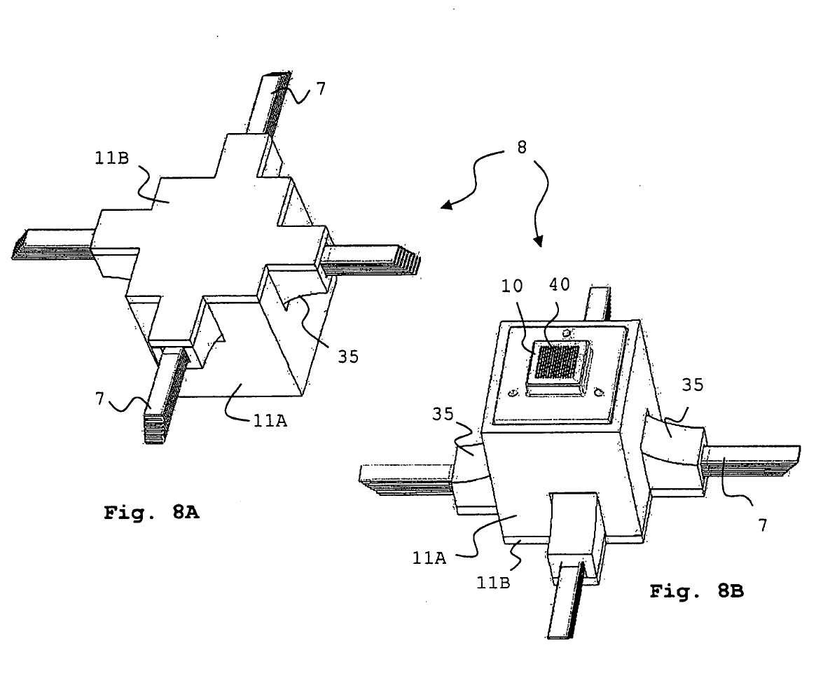

FIGS. 8A and 8B show an alternative embodiment of an optical board connector assembly according to an embodiment of the invention.

In FIG. 1 an optical system 1 is shown comprising a backpanel 2 and a system card 3 with an embedded device 4. The embedded device 4 may e.g. be an active optical or electro-optical component, such as a combination of a vertical cavity surface emitting laser (VCSEL) and a sensor, or a passive component such as a mirror or one or more embedded optical waveguides. A connector assembly 5 optically connects a plurality of optical cables 6 via the off-board optical cables 7 to a surface mounted optical board connector assembly 8. The surface mounted board connector 8 comprises a fibre fixation part or ferrule holder 9 having a ferrule part 10 protruding from the assembly 8. The fibre fixation part 9 cooperates with housing 11 of the board connector assembly 8 to control the gap G between the surface of the ferrule part 10 and the device 4. The optical cables 6, 7 may comprise a plurality of ribbon cables, each of said cables comprising a plurality of optical fibres. Optical signals may be transferred over those optical fibres to or from the device 4. The device 4 is embedded in the system card or PCB 3 and connected to other components (not shown) via waveguide 12.

FIGS. 2A-2C show various aspects of the fibre fixation part 9. The fibre fixation part 9 has a step-like shape. The ferrule part 10 is preferably a high-density ceramic plate with two-dimensional array of through-holes 20 for individual optical fibres. The holes 20 comprise substantially straight edges 21, as most clearly visible in FIG. 2B. Preferably the edges 21 of the holes 20 have an octagonal shape, as shown in FIG. 2B. The ferrule part 10 is thin, e.g. in a range of t=0.3-0.5 mm, allowing the provision of a large amount of substantially parallel through-holes 20 per unit area. Moreover the holes 20 preferably are tapered, i.e. the dimension d1 at the entrance side for the fibres is larger than the dimension d2 at the fibres stopping side to facilitate insertion of the optical fibres. The dimension d2 is e.g. in the range of 125-128 micron, such as 127 micron, while the pitch, i.e. the distance between adjacent holes 20, is e.g. in the range of 0,15-0,30 mm, e.g. 0,25 mm or 0,2 mm. Such a configuration enables a low loss connection between a large two-dimensional array of optical fibres and a device 4, at least for multimode signals. The fibre fixation part 9 further comprises a support part or lip 22 for maintaining said fibre fixation part 9 in the housing 11 of the optical board connector assembly 8 (shown in FIGS. 3, 4, 7A and 7B) and location surfaces 23. Fibre fixation part 9 also includes guidance openings 24 for receiving alignment pins 52 (Figs. SA and 5B). The ferrule part 10 is the subject of a co-pending patent application (“Ferrule assembly for optical fibres”) of the applicant of the same date. The features and advantages of the holes 20 and the method for manufacturing these holes, the mould and method for manufacturing such a mould are herewith incorporated by reference. Alternatively, a cable connector assembled at the backside of the ferrule assembly 9 may comprise alignment pins that protrude through the openings 24 such that these pins can be inserted in holes (corresponding in location with that of the pins 52 in FIGS. 5A and 5B) for positioning.

The fibre fixation part 9 comprises a cavity (not visible in FIG. 2A) opposite to the ferrule plate 10 to receive the optical fibres.

FIG. 3 shows an exploded view of an optical board connector assembly 8 according to an embodiment of the invention comprising a housing part 11A and a housing cover 11B. Further FIG. 3 displays a plurality of optical cables 7 bundled by bundle epoxy elements 30 and fixated in two fibre fixation parts 9. It should be appreciated that the optical cable assembly 8 may be suitable for more or less optical cables 7 and more or less fibre fixation parts 9 as e.g. shown in FIGS. 8A and 8B.

The housing part 11A comprises entrances 31 for the optical cables 7. The entrances 31 are provided with internal structures 32 to position and/or hold the bundle epoxy elements 30. Further the housing part 11A comprises a support structure 33 adapted to cooperate with the support parts 22 of the fibre fixation parts 9 to allow the ferrule plate 10 to protrude beyond the housing 11A. The housing part 11A also comprises mounting elements 34 for mounting the housing 11 to the board 3, e.g. by employing the housing 54 of the embedded device 4, as shown in FIG. 6. Further the housing part 11A comprises curved sections 35 to guide the optical cables 7 from the entrances 31 to the holes 20 of the fibre fixation parts 9. The radius of the curved sections 35 may be in the range below 5 mm, e.g. 2 mm especially if the optical fibres are of plastic (POF). Such a small curvature may diminish the total height H (see FIG. 6) of the board connector assembly 8 considerably.

The housing top 11B comprises curved sections 36 and resilient members 37, such as springs. The functions of these features will be described with respect to FIGS. 7A and 7B. The housing top 11B is sized to fit with the housing part 11A to constitute an appropriate board connector housing 11 for the assembly 8.

FIG. 4 shows a view of the optical board connector assembly 8 of FIG. 3 in an assembled state. Identical reference numerals are used to indicate identical features. Clearly the fibre fixation part 9 with the ferrule part 10 protrudes from the connector housing 11A. The holes 20 (see FIG. 2A) fixate individual optical fibres 40 of the optical cables 7.

Next the connection of the optical board connector assembly 8 to an embedded optical device 4 will be described.

FIGS. 5A and 5B show a system card or PCB 3 comprising an embedded device 4. The device 4 is exposed by a cavity 50 in the PCB 3. The PCB 3 is covered by a plate 51 formed of a material having a low coefficient of thermal expansion, e.g. a ceramic plate, that is provided with a hole substantially matching the size of the cavity 50. The distance D between the surface of the ceramic plate 51 and the top of the embedded device 4 is well controlled and measures approximately 1.5 mm. The plate 51 comprises or receives alignment elements 52 that cooperate with corresponding elements of the board connector assembly 8. This alignment system is the subject of a co-pending patent application (“Optical alignment system”) of the applicant filed at the same date and is incorporated with respect to the alignment features and method by reference. The plate 51 further comprises positioning elements 53 for positioning a housing 54 for the embedded device 4. In FIG. 6, the optical board connector assembly 8 is connected optically to the board embedded device 4, leaving a gap G (see FIG. 1) between the terminal ends of the optical fibres 40 and the device 4. The gap G preferably is 20 micron and can be controlled with a deviation of e.g. 5 to 10 micron when connecting the housing 11 and housing 54. This mounting is facilitated by employing the mounting elements, such as latches 34, by e.g. snap fitting.

FIGS. 7A and 7B show cross sections along 7A-7A of FIG. 4 and along 7B-7B of FIG. 6 of the optical board connector assembly respectively. FIG. 7A shows the board connector assembly 8 when no connection has yet been made to the embedded device 4. The springs 37 are pre-biased such that the fibre fixation part 9 or at least a part of the ferrule part 10 protrudes from the housing 11 over a distance P1. The support structure 33 of the connector and the support part 22 of the ferrule part 10 cooperate as to prevent the fibre fixation part 9 from being pushed out of the housing 11. The curved sections 36 of the housing 11 are shaped such that an open space 70 exists if all optical cables 7 are applied. This space 70 allows the ribbon optical cables 7 to be deformed in the housing 11 as displayed in FIG. 7B. This deformation is initiated by float in the z-direction of the fibre fixation part 9 if the board connector 8 is optically connected to the embedded device 4 such that the fibre fixation part now only protrudes over a distance P2, wherein P2<P1. This z-float permits that the support structure 33 and the support part 22 to be driven apart, as seen in FIG. 7B.

The surfaces 23 of the fibre fixation part or ferrule holder 9 bear against the top surface of the plate 51. Because the thickness of the plate 51, the distance of the top surface of the board 3 to the device 4 and the distance E between the surface 23 and the outer surface of the ferrule plate 10 can be carefully controlled, the gap G can be held with a tight tolerance.

FIGS. 8A and 8B finally show an alternative embodiment of an optical board connector assembly 8 according to the invention. In this embodiment multiple ribbon optical cables 7 are employed while using a single protruding fibre fixation part 9.

1. Optical board connector assembly for optically connecting an array of optical fibres to a circuit board embedded device (4) comprising:
a connector housing comprising a support structure;
at least one fibre fixation part characterized in that said fibre fixation part comprises a ferrule part for containing said optical fibres and a support part adapted to cooperate with said support structure such that said ferrule part protrudes at least partly from said connector housing.

2. Optical board connector assembly according to claim 1, wherein said assembly comprises at least one resilient member adapted to exert a force on said fibre fixation part in the direction of said protruding ferrule part.

3. Optical board connector assembly according to claim 2, wherein said at least one resilient member is prebiased.

4. Optical board connector assembly according to claim 2, wherein said connector housing comprises a space adapted to accommodate said optical fibres in a variety of bending states.

5. Optical board connector assembly according to claim 1, wherein said ferrule part comprises a two-dimensional high-density array of holes for containing said optical fibres.

6. Optical board connector assembly according to claim 1, wherein said ferrule part comprises a plurality of high-density through-holes comprising substantially straight edges.

7. Optical board connector assembly according to claim 6, wherein said holes have a substantially polygonal shape, preferably octagonal.

8. Optical board connector assembly according to claim 1, wherein said connector housing is adapted to allow float of said fibre fixation part in one or more directions.

9. Optical board connector assembly according to claim 1, wherein said fibre fixation part comprises a cavity for receiving said optical fibres.

10. Optical board connector assembly according to claim 1, wherein the fibre fixation part includes a location surface positioned a distance from an outer surface of the ferrule part in the direction of protrusion of the ferrule part.

11. Optical board connector assembly according to claim 10, wherein the location surface includes an opening for receiving an alignment pin.

12. Optical board connector assembly according to claim 10, wherein the connector includes a plate against which the location surface abuts.

13. Fibre fixation part for use in an optical board connector assembly according to claim 1.
